(19) United States
(12) Patent Application Publication
(10) Pub. No.: US 2016/0015220 A1
(43) Pub. Date: Jan. 21, 2016

(54) COMBINATION FOOD AND BEVERAGE CARRIER

(71) Applicant: C Deans List LLC, Wayland, MA (US)

(72) Inventors: Cassandra Dean, Wayland, MA (US); Benjamin L. White, Chestnut Hill, MA (US); Peter Marc Carpinteri, Somerville, MA (US); Lucy Deborah Dean, Wayland, MA (US)

(73) Assignee: C Deans List LLC, Wayland, MA (US)

(21) Appl. No.: 14/336,460

(22) Filed: Jul. 21, 2014

(51) Int. Cl. A47J 47/14; B31B 1/62; B65B 5/02; B65D 5/00; B65D 5/36

(52) U.S. Cl. CPC A47J 47/14; B65D 5/0085; B65D 5/36; B65B 5/026; B31B 1/62

(57) ABSTRACT

A combination food and beverage carrier, and method of manufacturing and assembling the carrier, is disclosed. The combination food and beverage carrier includes a sleeve and a food carrier connected to the sleeve. The sleeve has a tapered configuration. The food carrier has a plurality of sides and a base connected to one of the sides and having at least one tab that engages with a corresponding aperture in another one of the sides.

### FIELD

The disclosed embodiments are generally directed to disposable food carriers, and more particularly to structures suitable for holding an article of food while supporting a beverage container.

### BACKGROUND

While holding a beverage and food container at the same time, dining may be difficult as one must maneuver the food container and beverage into one hand to be able to eat with a second. In an attempt to solve this problem, disposable structures for supporting a beverage container and an article of food at the same time have been developed. Examples include U.S. Pat. No. 6,988,614 and U.S. Pat. No. 7,232,055. However, such known structures do not always provide a satisfactory solution.

### SUMMARY

In one embodiment, a food and beverage carrier that can be expanded from a substantially planar, unassembled configuration to a three-dimensional, assembled configuration is disclosed. The carrier includes a sleeve having opposed walls and a top opening into which a beverage container is insertable for supporting the beverage container. The carrier also includes a food carrier connected to the sleeve, the food carrier being configured to support an article of food. The sleeve is downwardly tapered from the top opening to a bottom of the sleeve. The food carrier has at least two sides and a base, the base being connected to one of the sides and having at least one tab, the at least one tab engaging with a corresponding aperture located in another one of the sides.

In another embodiment, a method of assembling a carrier having a sleeve and a food carrier, the carrier having a substantially planar, unassembled configuration that is expandable into a three-dimensional, assembled configuration, is disclosed. The method includes opening the food carrier having at least two sides and a base, the base being connected to one of the sides and having at least one tab that engages with at least one corresponding aperture formed in another one of the sides. The method also includes inserting the at least one tab into the at least one corresponding aperture. The method further includes opening the sleeve having a tapered configuration from a top opening to a bottom of the sleeve.

In still another embodiment, a method of assembling a carrier having a substantially planar, unassembled configuration that is expandable into a three-dimensional, assembled configuration, is disclosed. The method includes creating a template for the carrier, the template having a first half and a second half, each one of the first half and the second half having a part of a sleeve and a part of a food carrier, the first half being connected to the second half. The method also includes creating fold lines in each one of the first half and the second half to define at least one side of the food carrier, a connector and at least one attachment portion. The method further includes applying glue lines to a first connector and a first attachment portion of the first half, aligning the first connector and the first attachment portion of the first half with a second connector and a second attachment portion of the second half, respectively, and securing the first and second halves together to form an unassembled carrier. The unassembled carrier includes the sleeve having a tapered configuration from a top opening to a bottom of the sleeve and the food carrier having at least two sides and a base being connected to one of the sides, the base having at least one tab that engages with at least one corresponding aperture formed in another one of the sides. The method also includes opening the food carrier, inserting the at least one tab into the at least one corresponding aperture, and opening the sleeve.

In yet another embodiment, a method of assembling a carrier having a substantially planar, unassembled configuration that is expandable into a three-dimensional, assembled configuration, is disclosed. The method includes creating a template for the carrier, the template having a first half and a second half, each one of the first half and the second half having a part of a sleeve and a part of a food carrier. The method also includes creating fold lines in each one of the first half and the second half to define at least one side of the food carrier, a connector and at least one attachment portion. The method further includes applying glue lines to a first connector and a first attachment portion of the first half, aligning the first connector and the first attachment portion of the first half with a second connector and a second attachment portion of the second half, respectively, and securing the first and second halves together to form an unassembled carrier. The unassembled carrier includes the sleeve having a tapered configuration from a top opening to a bottom of the sleeve and the food carrier having at least two sides and a base being connected to one of the sides, the base having at least one tab that engages with at least one corresponding aperture formed in another one of the sides. The method also includes opening the food carrier, inserting the at least one tab into the at least one corresponding aperture, and opening the sleeve.

In another embodiment, a method of assembling a carrier having a substantially planar, unassembled configuration that is expandable into a three-dimensional, assembled configuration, is disclosed. The method includes creating a template for the carrier, the template having a first half and a second half, each one of the first half and the second half having a part of a sleeve and a part of a food carrier, the first half being connected to the second half. The method also includes creating fold lines in each one of the first half and the second half to define at least one side of the food carrier. The method further includes forming slits in first half, corresponding slits in the second half, and engaging the slits of the first half with the corresponding slits of the second half to form an assembled carrier. The assembled carrier includes the sleeve having a tapered configuration from a top opening to a bottom of the sleeve and the food carrier having at least two sides and a base being connected to one of the sides.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

In the drawings, each identical or nearly identical component that is illustrated in various figures is represented by a like numeral. For purposes of clarity, not every component may be labeled in every drawing. In the drawings:

FIG. 1 is a perspective view of an embodiment of a food and beverage carrier in an assembled configuration;

FIG. 2 is a rear elevational view of the carrier shown in FIG. 1;

FIG. 3 is a top plan view of the carrier shown in FIG. 1;

FIG. 4 is a bottom plan view of the carrier shown in FIG. 1;

FIG. 5 is a perspective view of another embodiment of a food and beverage carrier in an assembled configuration;

FIG. 6 is a top plan view of the carrier shown in FIG. 5;

FIG. 7A is a plan view of the carrier shown in FIG. 1 in a flat, unassembled configuration;

FIG. 7B is a plan view of a template of the carrier shown in FIG. 1;

FIG. 8 is a plan view of a template of the carrier shown in FIG. 5;

FIG. 9A is a plan view of another embodiment of a food and beverage carrier in a flat, unassembled configuration;

FIG. 9B is a plan view of a template of the carrier of FIG. 9A;

FIG. 10A is a plan view of another embodiment of a food and beverage carrier in a flat, unassembled configuration; and

FIG. 10B is a plan view of a template of the carrier of FIG. 10A.

### DETAILED DESCRIPTION

The present application relates to a disposable food and beverage carrier that is configured to be a single, flattened piece in an unassembled configuration and that is easily expandable into a three-dimensional assembled configuration for supporting an article of food and a beverage container.

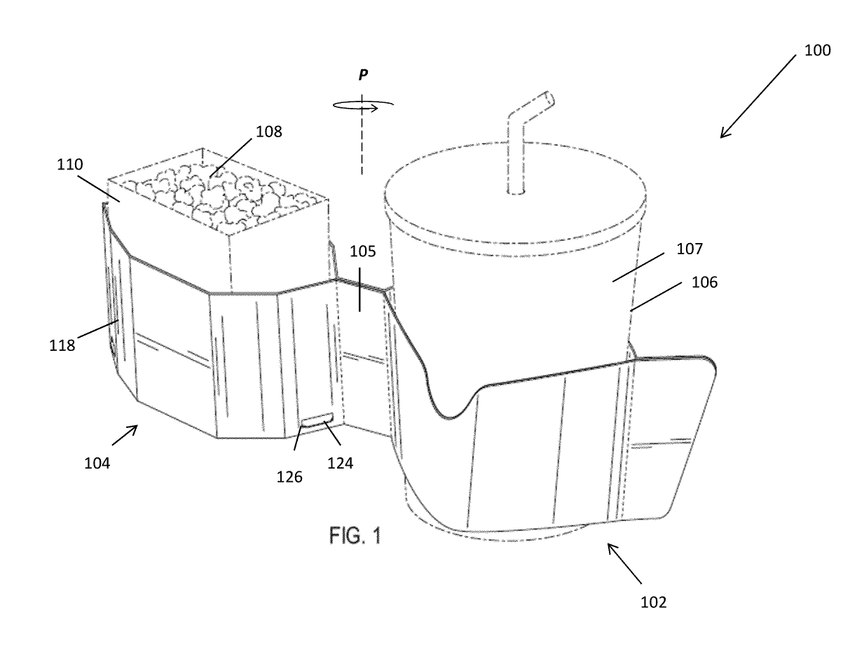

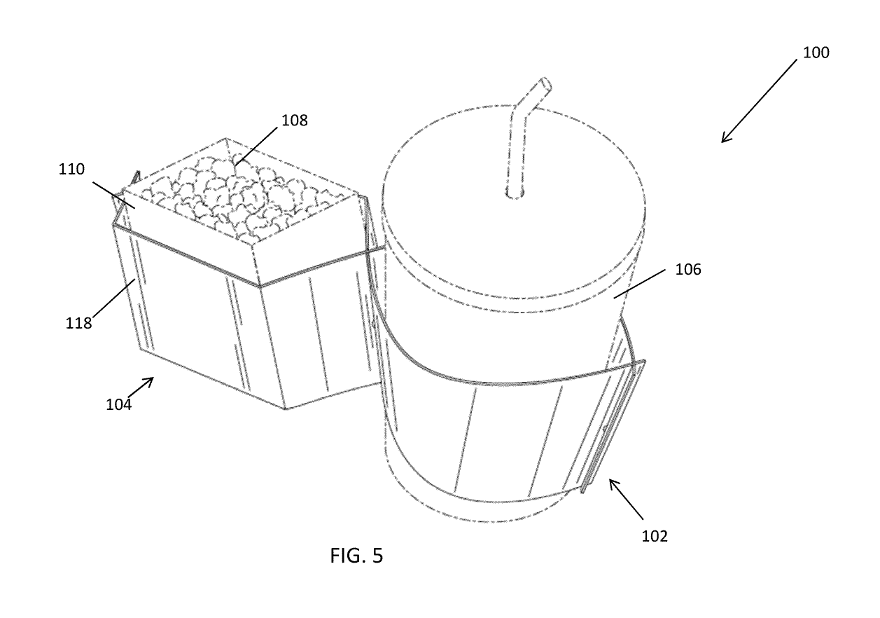

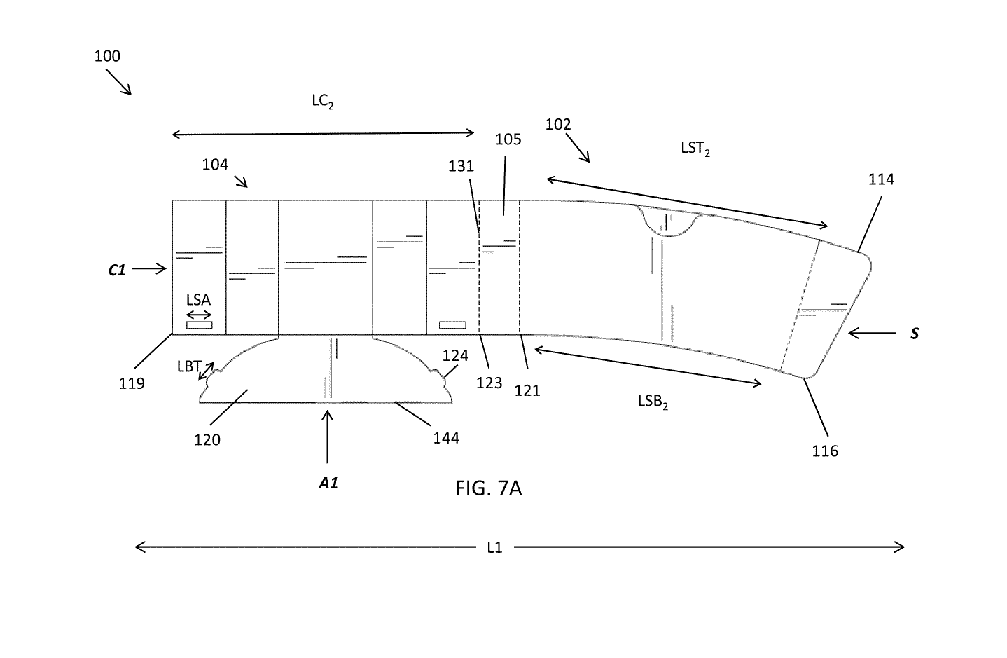

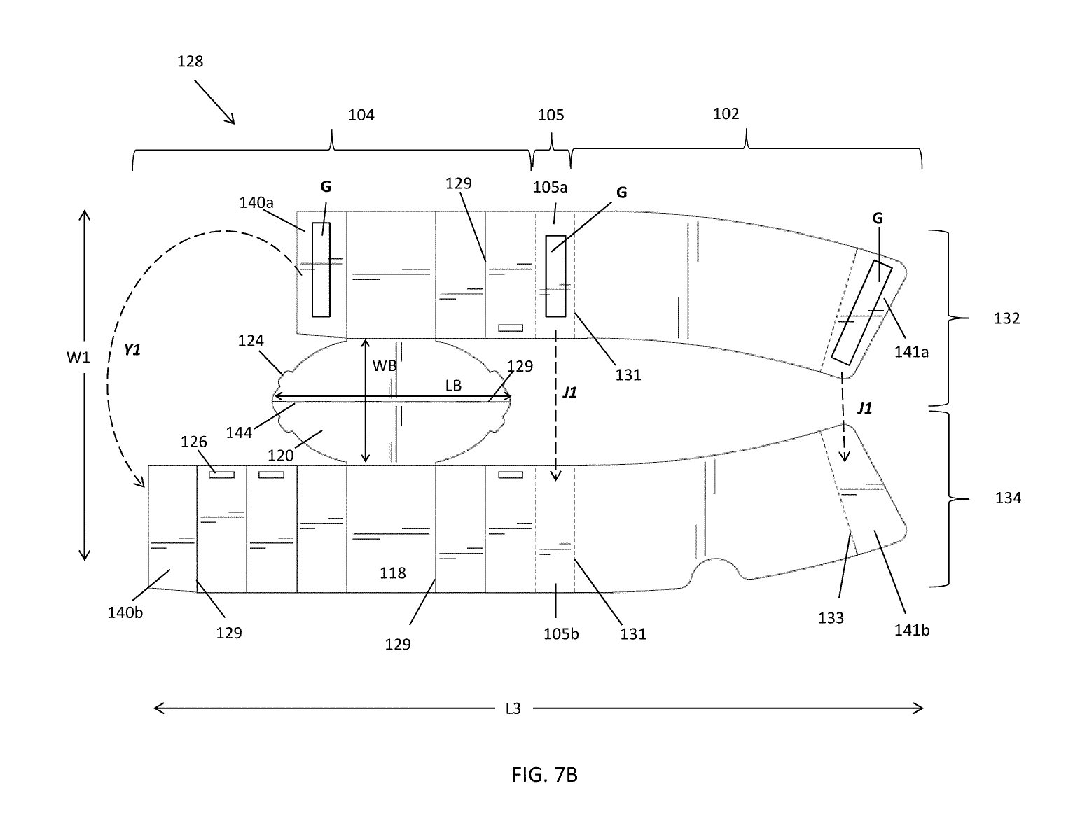

According to one aspect, a combination food and beverage carrier 100 (hereinafter referred to as “carrier”) is configured to support an article of food 108 and a beverage container 106 when in an assembled configuration (see, e.g., FIGS. 1 and 5). For purposes herein, an assembled configuration may include an open or three-dimensional configuration of the carrier 100 in which a beverage container and/or an article of food may be supported. In some embodiments, the carrier 100 has an unassembled configuration (see FIGS. 7A, 8, 9A, and 10A), which can be easily expanded into the assembled configuration. For purposes herein, an unassembled configuration may include a flattened or two-dimensional configuration of the carrier 100 after manufacturing but before the carrier 100 has been assembled into a three-dimensional configuration for use.

In some embodiments, the carrier 100 is expanded from the unassembled configuration to the assembled configuration via snapping or popping up of the unassembled carrier 100. In one embodiment, the unassembled carrier 100 is a single piece or structure (see, e.g., FIG. 7A), and, in some embodiments, the unassembled carrier 100 is a substantially planar structure. When assembled, the carrier 100 may extend vertically to support an article of food 108 and a beverage container 106.

FIG. 1 shows a perspective view of the carrier 100 in an assembled configuration, according to one embodiment. As illustrated in FIG. 1, the carrier 100 includes a sleeve 102 configured to support a beverage container 106 (e.g., a bottle, a can, a glass, a cup, or another container suitable for holding a beverage), and a food carrier 104 configured to support an article of food 108 or, as is shown, configured to support a container 110 holding the article of food 108.

Although the carrier 100 is shown as having one sleeve 102 and one food carrier 104, the carrier 100 may have more than one food carrier 104 and/or more than one sleeve 102. In some embodiments, the carrier 100 has one sleeve 102 and more than one food carrier 104. In one embodiment, for example, the carrier 100 includes one sleeve 102 and two food carriers 104. Carriers 100 having more than one sleeve 102 and/or more than one food carrier 104 may have any suitable configuration. For example, in the embodiment having one sleeve 102 and two food carriers 104, the sleeve 102 may be positioned between the two food carriers 104.

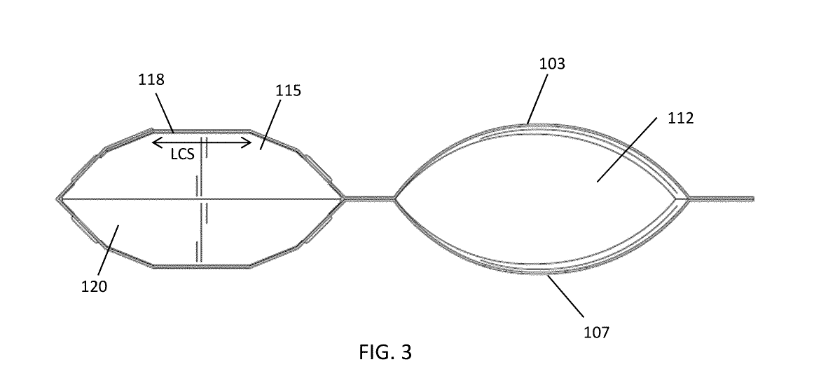

According to another aspect, the sleeve 102 is configured to support the beverage container 106. As shown in FIG. 1, the sleeve 102 may be configured to provide vertical support to the beverage container 106, that is, the sleeve 102 may extend vertically and around an exterior surface 107 of the beverage container 106. In some embodiments (see, e.g., FIG. 3), the sleeve 102 has first and second opposed sides 103, 107, which, in the assembled configuration, form an opening 112 into which the beverage container 106 may be inserted and supported. The opening 112 may have an oval shape, although the opening 112 may have any other shape suitable for supporting the beverage container 106. For example, the opening 112 may have a circular, square, rectangular, or elliptical shape. The opening 112 also may be the shape of a football. In one embodiment, the shape of the sleeve 102 and, thus the opening 112, corresponds to the shape of the beverage container 106, such that the shape of the sleeve 102 conforms to the exterior surface 107 of the beverage container 106. In such an embodiment, the sleeve 102 need not have a bottom surface or base to support the beverage container 106.

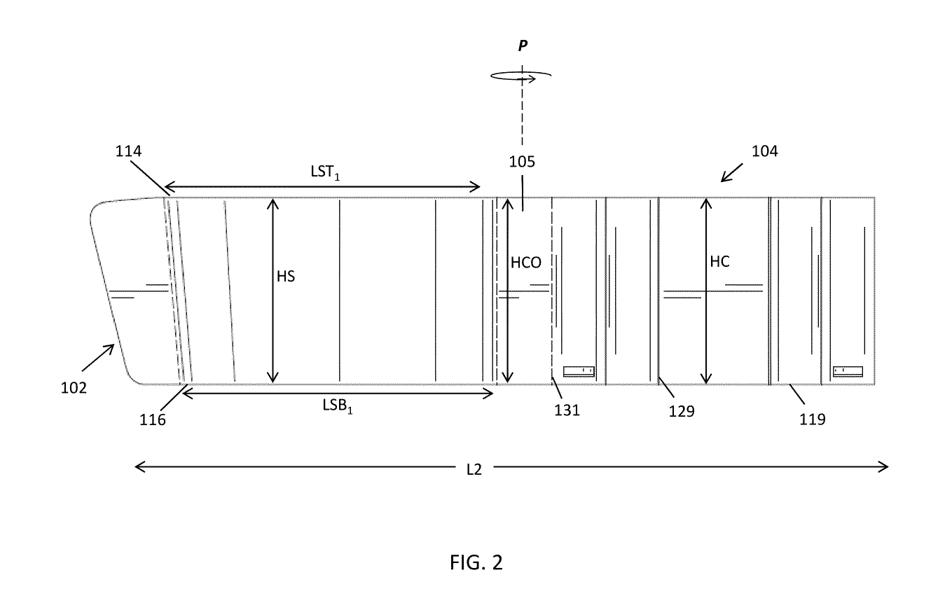

In one embodiment, as illustrated in FIG. 2, a front elevational view of the carrier 100 of FIG. 1, the sleeve 102 has a tapered configuration, in which the cross-sectional size of a top 114 of the sleeve 102 is larger than a cross-sectional size of a bottom 116 of the sleeve 102. In other embodiments, the top 114 of the sleeve 102 has a length LST in one direction that is larger than a corresponding length LSB of the bottom 116 of the sleeve 102 in the same direction. In an oval embodiment, LST and LSB correspond to lengths of the sleeve 102 along the lateral axis. In embodiments having a circular opening, the lengths LST and LSB correspond to the diameter of the top and bottom of the assembled sleeve 102.

In one example, the length LST₁ of the top 114 of the sleeve 102 is between about 3.5 inches and 4.5 inches in the assembled configuration (see FIG. 2), and the length LST₂ of the top 114 of the sleeve 102 is between about 5 inches and 6 inches when the sleeve 102 is in the flat, unassembled configuration (see FIG. 7A). In one example, the length LSB₁ of the bottom 116 of the sleeve 102 is between about 3 inches and 4 inches in the assembled configuration (see FIG. 2), and the length LSB₂ of the bottom 116 of the sleeve 102 is between about 4.5 inches and 5.5 inches when the sleeve 102 is in the flat, unassembled configuration (see FIG. 7A). The sleeve 102 may have any height suitable for supporting the beverage container 106. In some embodiments, the height HS of the sleeve 102 is between about 2 inches and 3 inches. Although dimensions for the length LST₁, LST₂ and height HS of the sleeve 102 are described, a person having ordinary skill in the art should appreciate that the sleeve 102 may have any length or height suitable for supporting the beverage container 106.

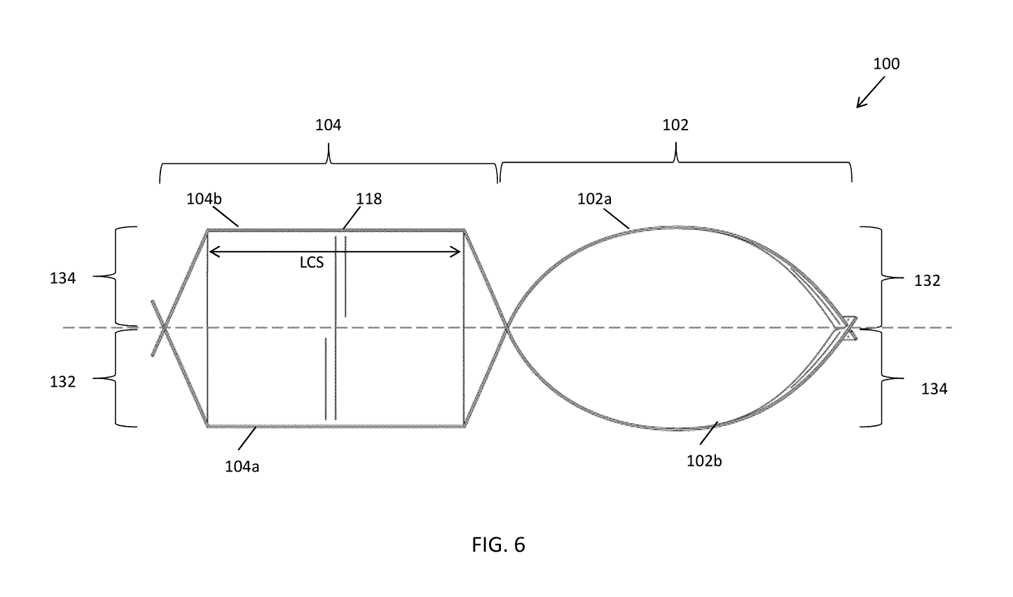

According to another aspect, the food carrier 104 is configured to support an article of food. As shown in FIG. 6, the food carrier 104 has a plurality of sides 118 and a base 120, which, when assembled, form a vertically extending structure (see FIG. 1) with an opening 115 into which the article of food 108 can be inserted and supported. In one embodiment, the assembled food carrier 104 may have the shape of a decagon, an octagon, a hexagon, a pentagon, a square or the like. In some embodiments, the number of sides 118 of the food carrier 104 corresponds to the shape of the opening 115 of the food carrier 104. For example, for food carriers 104 having a decagonal, an octagonal, a hexagonal, a pentagonal, or a square shape, the food carriers 104 may have 10, 8, 6, 5, or 4 sides, respectively. In other embodiments, the food carrier 104 may have more or fewer sides 118. In some embodiments, for example, the food carrier 104 may have at least two sides 118 that are joined together to form the vertically extending structure for supporting the article of food 108. In some examples, the sides 118 of the food carrier 104 are defined by fold lines 129 formed in a template 128 of the carrier 100.

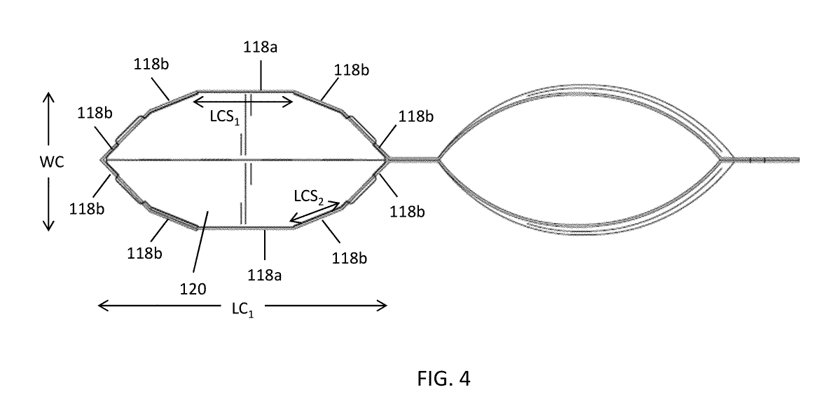

Each side 118 of the food carrier 104 has a length LCS (see FIG. 3), and the length LCS of the sides 118 depends upon the shape of the carrier (e.g., whether the food carrier 104 is formed as a square, a pentagon, a hexagon, an octagon, or a decagon). If the food carrier 104 has six or more sides, for example, the length LCS may be between about 0.5 inches and 2.5 inches. All the sides 118 of the food carrier 104 may have the same length LCS, however, the sides 118 of the food carrier 104 also may have different lengths LCS. In one embodiment, as shown in FIG. 4, the food carrier 104 has two sides 118a having a first length LCS₁ and eight sides 118b having a second length LCS₂. In some embodiments, the first length LCS₁ is larger than the second length LCS₂. In some embodiments, the first length LCS₁ is between about 1.5 inches and about 2.5 inches and the second length LCS₂ is between about 0.5 inches and 1.5 inches. In one embodiment, the first length LCS₁ is about 1.75 inches and the second length LCS₂ is about 1.0 inch.

The food carrier 104 may have any height HC suitable for supporting the article of food 108, or the container 110 holding the article of food 108. In some embodiments, the height HC of the food carrier 104 is between about 2 inches and 3 inches. A person having ordinary skill in the art should appreciate that the height HC of the food carrier may be the same as the height HS of the sleeve, although the heights HC, HS of the food carrier and the sleeve also may differ.

The opening 115 of the assembled food carrier 104 may be any size and shape suitable for supporting the article of food 108. For example, the opening 115 of the food carrier 104 may have a triangular, square, hexagonal, or another polygonal shape. The opening 115 of the food carrier 104 also may have a circular or elliptical shape. In some embodiments, the number of sides 118 of the food carrier 104 corresponds to the desired shape of the opening 115 of the food carrier 104.

The food carrier 104 may be any size suitable for supporting the article of food 108. For example, as shown in FIG. 4, in the assembled configuration, the length LC₁ of the food carrier 104 along a lateral axis may be between about 4 inches and about 5.5 inches. As shown in FIG. 7A, the length LC₂ of the food carrier 104 in the flat, unassembled configuration may be between about 5 and about 6.5 inches. The assembled food carrier 104 also may have a width WC (e.g., the width along a longitudinal axis), and in some embodiments, the width WC of the food carrier 104 is between about 2 inches and about 3 inches, although other widths may be used. In some embodiments, the width WC of the food carrier 104 is between about 2.5 and 3.0 inches in the assembled form. Although dimensions are provided for the length LC₁, LC₂ and width WC of the food carrier 104 in the assembled and unassembled configurations, any lengths and widths suitable for supporting the article of food may be used 108.

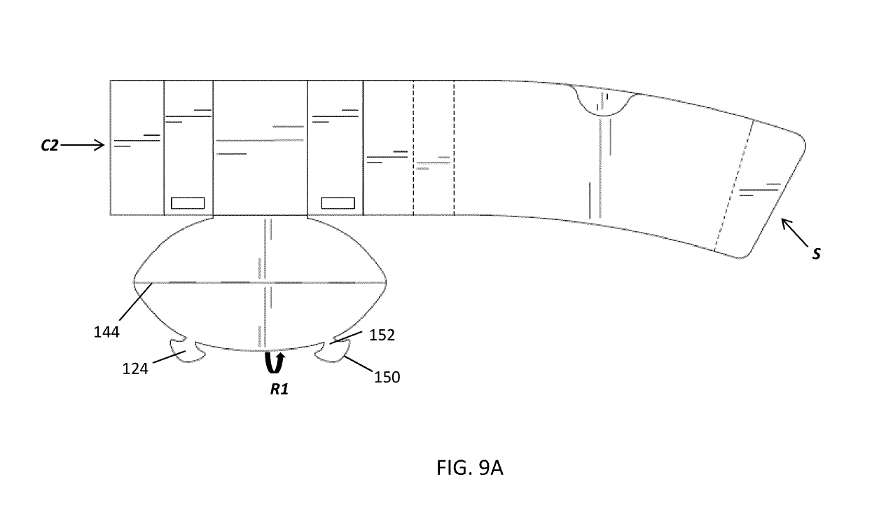

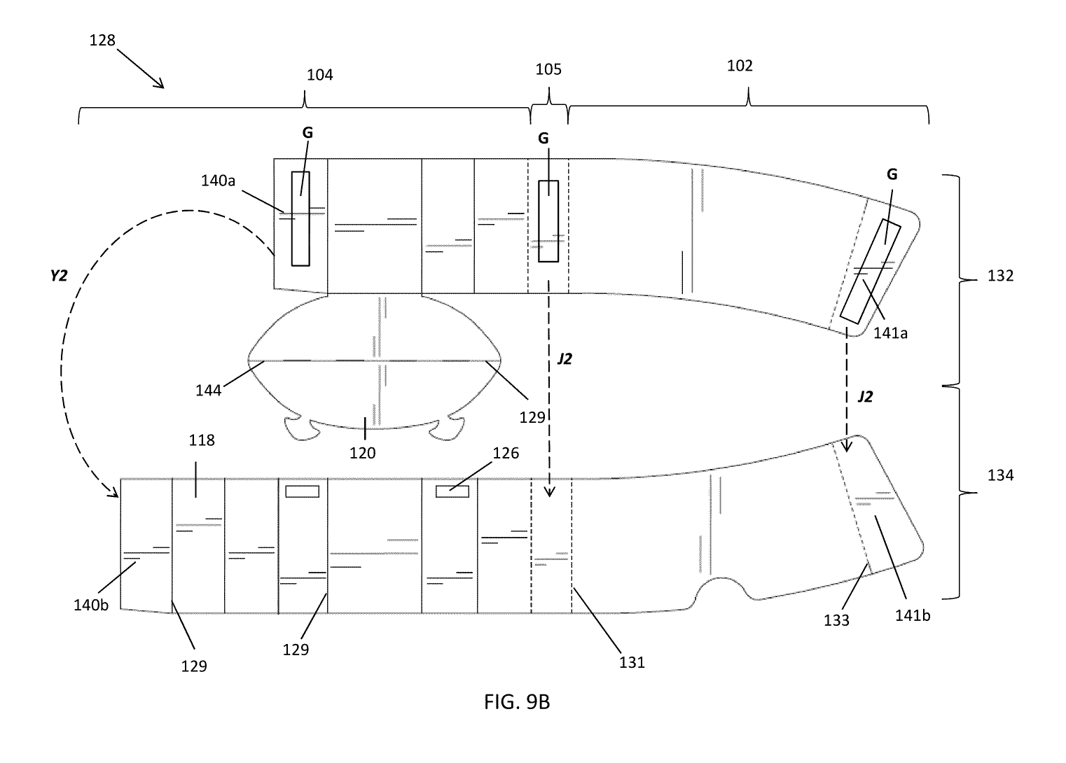

In some embodiments, the base 120 is attached to the bottom 119 of the food carrier 104 (see FIG. 7A). As illustrated in FIGS. 7B and 9B, the base 120 of the food carrier 104 may be connected to at least one side 118 of the food carrier 104. In some embodiments, the base 120 is permanently attached to at least one side 118 of the food carrier 104, while, in other embodiments, the base 120 may be removably attached to at least one side 118 of the food carrier 104. FIG. 7B illustrates an embodiment in which the base is permanently connected to two opposed sides 118 of the food carrier 104 and is removably attachable to four other sides 118. FIG. 9B illustrates an embodiment in which the base 120 is permanently connected to only one side 118 of the food carrier 104, but is removably attachable to two other sides 118. A person having ordinary skill in the art should appreciate that the base 120 also may be permanently connected to more than two sides 118 of the food carrier 104. The base 120 also may be removably attachable to as few as one side 118 of the food carrier 104.

In some embodiments, the base 120 has at least one tab 124 that is configured to removably attach the base 120 to at least one side 118 of the food carrier 104. As is shown in FIGS. 1 and 7A, for example, the tab 124 is insertable into an aperture 126 located in one of the sides 118 of the food carrier 104. Typically, the location of the aperture 126 corresponds to the location of the tab 124. In one embodiments, the aperture 126 is located in a lower portion of the side 118 (e.g., the portion of the side closest to the bottom 119 of the food carrier 104). As is shown in FIG. 7B, in one embodiment, the base 120 has four tabs 124 that are insertable into four corresponding apertures 126.

Although four tabs 124 and four corresponding apertures 126 are shown in this figure, a person having ordinary skill in the art should appreciate that more or fewer tabs 124 and more or fewer corresponding apertures 126 may be used. For example, as is shown in FIG. 9B, the base 120 may have two tabs 124 that are inserted into two corresponding apertures 126, each of the apertures 126 being formed in a lower portion of one of the sides 118 of the food carrier 104. In some embodiments, the base 120 has only one tab 124 that is engaged with a corresponding aperture 126. In such an embodiment, the tab 124 may be larger than the tabs shown in FIGS. 7B and 9B. Typically, the number of tabs 124 corresponds to the number of apertures 126 (e.g., there are the same number of tabs 124 and corresponding apertures 126), although there could be more apertures 126 than tabs 124. For example, in one embodiment, the number of apertures 126 may be greater than the number of tabs 124 (e.g., the base may have four tabs 126 while there are six apertures 126). In such an embodiment, the consumer may choose the apertures 126 into which the tabs 124 are to be inserted to customize the shape and/or size of the food carrier 104.

A person having ordinary skill in the art should appreciate that the tabs 124 and apertures 126 may have any suitable shape and size for removably attaching the base 120 to the sides 118 of the food carrier 104. Additionally, although all the tabs 124 attached to the base 120 are shown to be the same in FIG. 7B, a person having ordinary skill in the art should appreciate that shape and size of the tabs 124 may differ from tab to tab. In some embodiments, as is shown in FIG. 7A, the tabs may have a trapezoidal shape, although the tabs also may have a triangular, square, circular, semicircular, or other suitable shape (see, e.g., FIG. 9). The apertures 126 also may have a rectangular shape, although other suitable shapes may be used.

In some embodiments, the shape and size of the tabs 124 corresponds to the shape and size of the corresponding apertures 126. Typically, the tabs 124 and corresponding apertures 126 are configured so that the tabs 124 are retained in the corresponding apertures 126 during use. In some embodiments, the natural bias of the carrier 100 in the two-dimensional configuration keeps the tabs 124 retained in the corresponding apertures 126. In other embodiments, the tabs 124 are shaped to engage with and be retained in the corresponding apertures 126. As shown in FIG. 9A, for example, the tabs may have a head portion 150 and a neck portion 152. In one embodiment, the size of the head portion 150 of the tab 124 is larger than the size of the corresponding aperture 126, such that once the tabs 124 are inserted into the corresponding apertures 126 the tabs 124 are retained.

In some embodiments, each tab 124 has a length LBT (see FIG. 7A), and in some embodiments, the length LBT of the tab 124 is between about 0.25 inches and about 0.75 inches, although other suitable lengths LBT of the tab 124 may be used for engagement with the aperture 126. In some embodiments, each aperture 126 has a length LSA, and in some embodiments, the length LSA of the aperture 126 is between about 0.25 and about 0.75 inches. In some embodiments, the length LSA of the aperture 126 is larger than the length LBT of the tab 124, and in some embodiments, the length LSA of the aperture 126 is only slightly larger than the length LBT of the tab 124.

The base 120 may have any suitable shape and size for supporting the article of food 108. In some embodiments, the size of the base 120 corresponds to the size of the assembled food carrier 104 or the size of the opening 115 of the assembled food carrier 104. As shown in FIG. 7B, the base may have a length LB, and in some embodiments, the length LB of the base may be between about 2.5 inches and about 5 inches, although other lengths may be used. In some embodiments, the length LB of the base 120 is between about 4.5 inches and about 5 inches. The base 120 also may have a width WB, and, in some embodiments, the width WB of the base 120 is between about 2 inches and about 3 inches wide, although other suitable widths may be used. In some embodiments, the width WB of the base is between about 2.5 inches and about 3 inches. The base may have a square, circular, hexagonal, rectangular, or another polygonal shape.

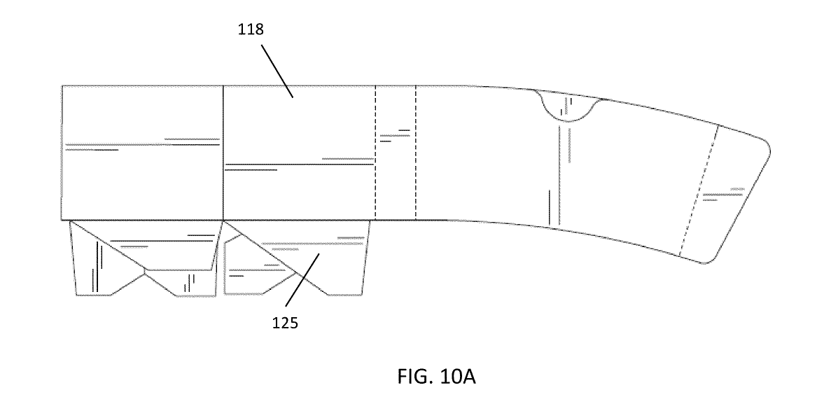

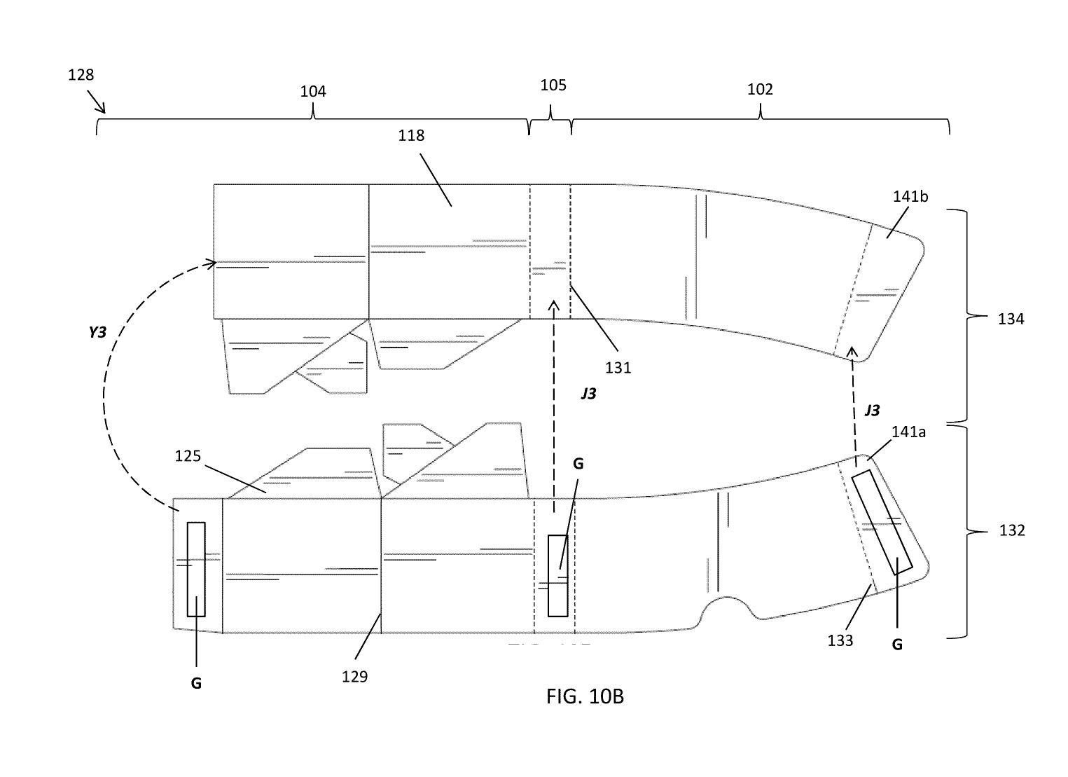

Although the food carrier 104 is shown as having a base 120 that is attached to at least one side 118, a person having ordinary skill in the art should appreciate the base 120 may have other configurations. For example, as shown in FIGS. 10A and 10B, each of the sides 118 of the food carrier 104 may have a tab 125 that extends downwardly from the side 118 of the food carrier 104. In some embodiments, the tabs 125 are configured to overlap (e.g., like a lock bottom closure) to create the base 120 during assembly.

As shown in FIG. 1, the sleeve 102 is connected to the food carrier 104. As illustrated in this figure, in one embodiment, the food carrier 104 may be connected to the sleeve via a connector 105 (e.g., a piece of paper or cardstock, a hinge or another suitable connector). In other embodiments (see, e.g., FIG. 5), the food carrier 104 is connected directly to the sleeve 102. A person having ordinary skill in the art should appreciate that while the food carrier 104 may be permanently attached to the sleeve 102, the food carrier 104 also maybe removably attachable to the sleeve 102.

In some embodiments, the connector 105 has a rectangular shape, as is shown in FIG. 1, although the connector 105 may have another suitable shape for connecting the sleeve 102 to the food carrier 104. In some embodiments, the connector 105 has a height HCO, which, as is shown in FIG. 2, may be the same as the height HS of the sleeve 102 and the height HC of the food carrier 104. The height HCO of the connector 105 also may be different than height HS of the sleeve 102 and/or the height HC of the food carrier, in other embodiments.

In some embodiments, the connector 105 is configured to allow the sleeve 102 and the food carrier 104 to pivot with respect to one another when the carrier 100 is in the assembled configuration (see arrow P in FIG. 1). This, in turn, may allow for a more versatile carrier 100, since the sleeve 102 and the food carrier 104 are able to independently move while the carrier 100 is supporting the beverage container 106 and article of food 108. This also may minimize the possibility of spilling the beverage or food article 108.

In some embodiments, movement between the sleeve 102 and the food carrier 104 is accomplished by forming fold lines 131 along the edges of the connector 105 (see, e.g., FIG. 7A). In some embodiments, the fold lines 131 are formed at the boundaries 121, 123 between the connector 105 and the sleeve 102 and between the connector 105 and the food carrier 104, respectively. The fold lines 131 also may be perforated or scored in some embodiments to further enhance movement between the sleeve 102 and food carrier 104.

The carrier 100 may have any size suitable for supporting the beverage container 106 and article of food 108. As shown in FIG. 7A and FIG. 2, for example, the length L1 of the carrier 100 may be between about 10 inches and 14 inches in the unassembled configuration, and the length L2 of the carrier 100 may be between about 9 inches and about 12 inches in the assembled configuration, respectively.

According to another aspect, the carrier 100 is configured to be disposable. In some embodiments, the carrier 100 is made of paper or of cardstock, although the carrier made be made of any other suitable material. The paper may have any suitable weight as this aspect of the disclosure is not limited in this regard. For example, the weight of the paper may be between about 4 point and 24 point, although any suitable paper weight may be used. A person having ordinary skill in the art should appreciate that the carrier 100 may be made of the same material or it may be made of a combination of different materials. A person having ordinary skill in the art should further appreciate that a portion of the carrier 100 (e.g., the sleeve 102) may be made of one material while another portion or portions of the carrier 100 (e.g., the food carrier 104) may be made of a different material.

In some embodiments, the carrier 100, or portions of the carrier 100, are configured to be reusable. For example, in some embodiments, the carrier 100 may be made of a durable plastic material, although other materials also may be used. For example, in some embodiments, the carrier 100, or portions of the carrier 100, may include a metal material. In some embodiments, portions of the carrier 100 are configured to be disposable while other portions of the carrier 100 are configured to be reusable. For example, in one embodiment, the sleeve 102 may be made of a reusable material while the food carrier 104 may be made of a disposable material.

According to still another aspect, a method of manufacturing the carrier 100 is disclosed. In some embodiments, the manufacturing process includes selecting the type of material or materials to be used to manufacture the carrier 100 (e.g., a paper material). The method also may include forming or creating a template 128 from the selected material(s). In some embodiments, creating the template 128 includes creating the template 128 via stamping, punching, or cutting out the template 128 from the desired material(s). In some embodiments, the step of preparing the template 128 is performed by hand (e.g., using a pair of scissors), while in other embodiments, the process of preparing the template involves using a machine known to one of ordinary skill in the art for automating the preparation of the template 128. Examples of templates 128 used to create the carrier 100 are shown in FIGS. 7B, 8, 9B, and 10B, each of which is a plan view of an interior side of the carrier 100, according to various embodiments. A person having ordinary skill in the art should appreciate that the template 128 may have a design or logo printed on the exterior and/or interior sides of the template 128, although not shown.

As shown in FIG. 15B, in one embodiment, the step of forming the template 128 includes forming a template 128 having first and second halves 132, 134 of the carrier 100, each half 132, 134 having a part of the sleeve 102, a part of the food carrier 104, and a part of the connector 105. The template 128 also includes the base 120 with four tabs 124 and corresponding apertures 126 in four of the sides 118 of the food carrier 104. A person having ordinary skill in the art should appreciate that each half 132, 134 of the food carrier may be different, as is shown, although in some embodiments, the first and second halves 132, 134 may be mirror images of one another. As illustrated in FIG. 7B, creating the template also includes forming fold lines 129 to define the sides 118, the attachment portions 140, and the base 120 of the food carrier 104. As show in this figure, a fold line 129 may be formed along a central portion or center line 144 of the base 120. Fold lines 131, 133 also may be created to define the connector and to define the attachment portions 141 of the sleeve 102, respectively. Typically, the fold lines 129, 131, 133 are created to facilitate manufacturing and assembly of the carrier. In some embodiments, the fold lines 131, 133 of the connector 105 and of the attachment portions 141 of the sleeve 102 may be scored or perforated. In one embodiment, the fold line 129 along the center line 144 of the base 120 also may be perforated or scored. In these embodiments, the perforated or scored lines may facilitate assembly of the unassembled carrier 100 and movement between the sleeve 102 and food carrier 104, may allow for a planar unassembled configuration of the food 100, and may allow for shipment of the carrier 100 in stacks.

Once the template 128 has been formed, glue lines G are applied to the attachment portions 140a, 141a and to the connector 105a of the first half 132 of the carrier 100. Next, the first and second halves 132, 134 of the carrier 100 are aligned and the first half 132 of the carrier 100 is secured to the second half 134 of the carrier 100. In some embodiments, aligning the first and second halves 134 of the carrier 100 includes aligning the attachment portions 141a, 141b of the sleeve 102 and aligning the connectors 105a, 105b (see, e.g., the line labeled J1). Aligning the first and second halves 132, 134 also may include overlapping the attachment portions 140a, 140b of the food carrier 104. In some embodiments, overlapping the attachment portions 140a, 140b of the food carrier 104 includes aligning an interior side of the attachment portion 141a of the first half 132 of the carrier 100 (e.g., the side of the attachment portion 141a having the glue line G) with the exterior side (not shown) of the attachment portion 141b of the second half of the carrier 100 (see, e.g., the line labeled Y1). Once aligned and secured, the attachment portions 141a, 141b of the food carrier 104 form a single side 118 of the food carrier 104. A person having skill in the art should appreciate that other methods for securing the first and second halves 132, 134 of the carrier 100 may be used (e.g., via staples or another suitable method of attachment). Once the first and second halves 132, 134 of the carrier 100 are secured together, the unassembled carrier 100 may be prepared for shipment to the consumer.

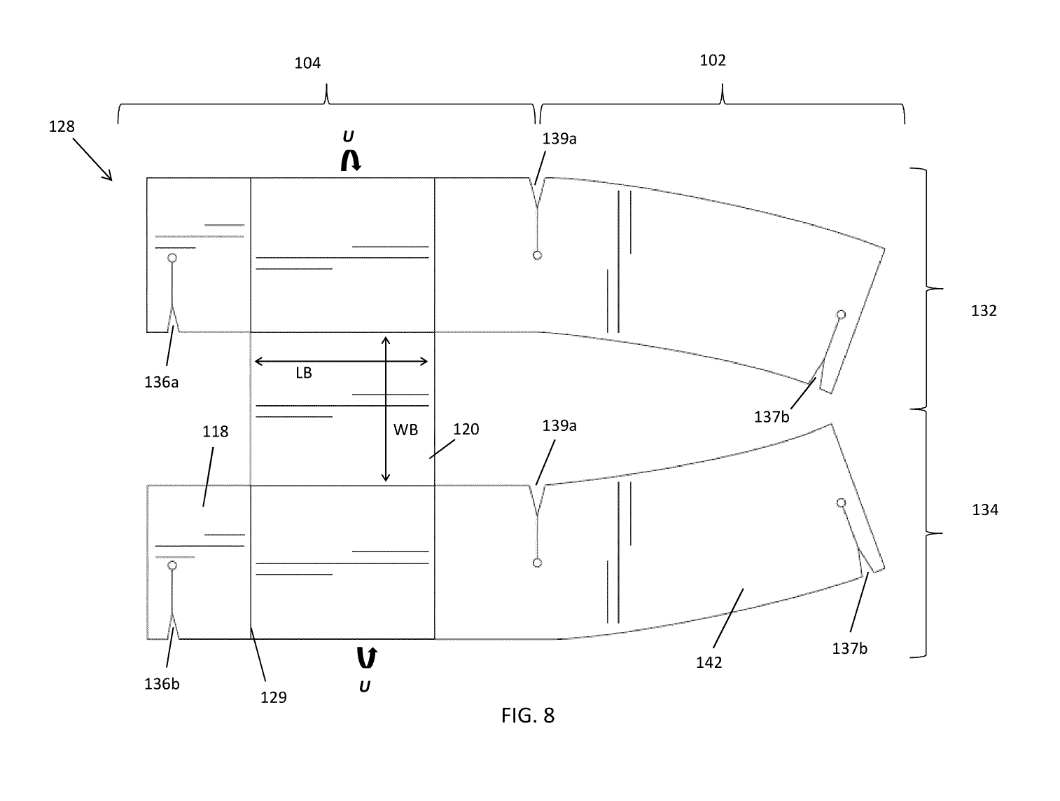

For the embodiment illustrated in FIG. 8, the process of manufacturing the unassembled carrier 100 includes forming a template having first and second halves 132, 134 of the carrier 100, each half 132, 134 having a part of the food carrier 104 and a part of the sleeve 102. The template includes slits 136a, 136b in two of the sides 118 of the food carrier 104, slits 137a, 137b in first and second sides 142 of the sleeve 102, and slits 139a, 139b at the boundary between the food carrier 104 and the sleeve 102. In some embodiments, fold lines 129 are formed to define the sides 118 and base 120 of the food carrier 104. In some embodiments, the template 128 shown in FIG. 8 also represents the flat, unassembled configuration of the carrier 100 of FIG. 5. As such, in some embodiments, the template 128 of FIG. 8, once manufactured, is ready for shipment to the consumer.

For the embodiment shown in FIG. 9B, the process of manufacturing includes forming the template 128 having first and second halves 132, 134 of the carrier 100, each half 132, 134 having a part of the sleeve 102, a part of the food carrier 104, and a part of the connector 105. Forming the template also includes creating a base 120 having two tabs 124 and forming corresponding apertures 126 in two of the sides 118 of the food carrier 104. Next, fold lines 129 may be created to define the sides 118, the base 120 and attachment portions 140 of the food carrier 104. Fold lines 131, 133 also may be created to define the connector 105 and to define the attachment portions 141 of the sleeve 102, respectively. In some embodiments, the fold lines 131, 133 of the connector 105 and/or of the attachment portions 141 of the sleeve 102 may be perforated or scored. The fold line along the center line 144 of the base 120 also may be perforated or scored. As with the embodiment shown in FIG. 7B, the process of manufacturing also includes applying glue lines G to the connector 105a and attachment portions 140a, 141a of the first half 132 of the carrier 100, and aligning the first and second halves 132, 134 for securement (see lines J2 and Y2). Once secured, the unassembled carrier 100 may be shipped to the consumer.

For the embodiment shown in FIG. 10B, the process of manufacturing involves creating the template 128 having first and second halves 132, 134 of the carrier 100, each half 132, 134 having a part of the sleeve 102, a part of the food carrier 104, and a part of the connector 105. Forming the template further includes forming tabs 125 that extend from each of the sides 118 of the food carrier 104. As with the examples above, forming the template includes forming fold lines 129, 131, 133 and, in some embodiments, scoring or perforating some of the fold lines (e.g., the fold lines 131, 133 that define the connector 105 and the attachment portions 141 of the sleeve 102). Also like other embodiments, the process involves applying glue lines G to the attachment portions 140a, 141a and the connector 105a of the first half 132 of the carrier 100 and aligning and securing the first half 132 and the second half 134 to one another. In this embodiment, the attachment portion 141a of the food carrier 104 is aligned with one of the sides 118 of the second half of the food carrier 104 (see line Y3).

As shown in FIG. 7B, the template 128 may have any suitable size for forming the carrier 100 with a sleeve 102 and a food carrier 104. In one embodiment, the template 128 has a length L3, and, in some embodiments, the length L3 of the template 128 is between about 12 inches and about 16 inches. The template 128 also may have a width W1, which, in some embodiments, is between about 6.5 inches and about 9 inches. Although dimensions of the template 128 of the carrier 100 are described, a person having ordinary skill in the art should appreciate that the template 128 may have any length L3 and width W1 suitable for forming the carrier 100.

According to another aspect, the carrier 100 is configured to be transported to the consumer in a flat, unassembled configuration. In some embodiments, shipping the carrier 100 includes shipping stacks of the flat, unassembled carriers 100 to the consumer.

According to still another aspect, a method of assembling the carrier 100 is disclosed. The process of using the carrier 100 may include receiving the flat, unassembled carrier 100 from a manufacturer or from a third-party supplier. In one embodiment, as shown in FIG. 7A, the method includes pressing on one of the sides of the food carrier 104 (see arrow C1) and/or pressing upward on the center line 144 of the base 120 of the food carrier 104 (see arrow A1). This, in turn, opens the food carrier 104 and moves the base 120 into a position substantially perpendicular to the sides 118 of the food carrier 104. The method also includes inserting the tabs 124 into the apertures 126 to secure the base 120 to the sides 118 of the food carrier 104. Once the food carrier 104 has been assembled, the sleeve 102 may be placed around the beverage container 106 and the article of food 108, or container 110 holding the article of food 108, may be placed in the food carrier 104. In some embodiments, placing the sleeve 102 around the beverage container involves pressing inwardly on the attachment portion 141 of the sleeve 102 (see arrow S) and/or pulling outwardly on one of the opposed sides 103, 107 of the sleeve 102 to create the opening 112 into which the beverage container 106 can be inserted.

In the embodiment illustrated in FIG. 9A, the method of assembling the carrier 100 includes pressing on one of the sides 18 of the food carrier 104 (see arrow C2 in FIG. 9A) and lifting the base 120 (see arrow R1) to open the food carrier 104 and move the base 120 into a position substantially perpendicular to the sides 118 of the food carrier 104. Similar to the embodiment shown in FIG. 7A, the tabs 124 are inserted into the apertures 126 to secure the base to the food carrier 104. Next, the sleeve 102 may be placed around a beverage container 106 and an article of food 108 may be inserted into the food carrier.

In some embodiments, as is shown in FIG. 8, the method of assembling the carrier 100 includes folding each of the sides 118 of the food carrier 104 into an upward or vertical position (see arrow U). In this position, the sides 118 may be substantially perpendicular to the base 120 of the food carrier 104. Next, a first slit 136a of the food carrier 104 (e.g., the slit 136a in one of the sides 118 of the food carrier 104 in the first half 132) is inserted into a second slit 136b of the food carrier 104 (e.g., the slit 136b the side 118 of the food carrier 104 in the second half). Next, the slits 139a, 139b located on the boundary between the food carrier 104 and the sleeve 102 are engaged with one another. In some embodiments, engaging the slits 139a, 139b at the boundary between the food carrier 104 and the sleeve 102 includes crossing the first half 132 of the carrier 100 over the second half 134 of the carrier 100, such that in the assembled form, the first half 132 of the food carrier 104a is aligned with the second half 134 of the sleeve 102b (see, e.g., FIG. 6). Finally, the slits 137a, 137b located in the opposed sides 142 of the sleeve 102 are engaged with one another. A person having ordinary skill in the art should appreciate that the slits 136, 137, 139 may be engaged in any order as this aspect of the disclosure is not limited in this regard.

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

What is claimed is:

1. A food and beverage carrier that can be expanded from a substantially planar, unassembled configuration to a three-dimensional, assembled configuration, comprising:
a sleeve, the sleeve having opposed sides and a top opening into which a beverage container is insertable for supporting the beverage container; and
a food carrier connected to the sleeve, the food carrier being configured to support an article of food;
wherein the sleeve is downwardly tapered from the top opening to a bottom of the sleeve; and
wherein the food carrier has at least two sides and a base, the base being connected to one of the sides and having at least one tab, the at least one tab engaging with a corresponding aperture located in another one of the sides.

2. The food and beverage carrier of claim 1, wherein a cross sectional size of the sleeve along a lateral axis is larger at a top of the sleeve than at the bottom of the sleeve.

3. The food and beverage carrier of claim 1, wherein the food carrier comprises ten sides.

4. The food and beverage carrier of claim 3, wherein the base has four tabs and the food carrier has four corresponding apertures.

5. The food and beverage carrier of claim 4, wherein a first aperture is located in a first side, a second aperture is located in a second side, a third aperture is located in a third side, and a fourth aperture is located in a fourth side.

6. The food and beverage carrier of claim 1, where the sleeve is connected to the food carrier via a hinge.

7. The food and beverage carrier of claim 6, wherein the sleeve is pivotable with respect to the food carrier about the hinge.

8. The food and beverage carrier of claim 1, wherein the sides of the food carrier form a hexagonal shape when the carrier is in an assembled position

9. The food and beverage carrier of claim 1, wherein at least a portion of the food carrier is disposable.

10. The food and beverage carrier of claim 1, wherein the food carrier is configured to be substantially two dimensional in the unassembled position.

11. A method of assembling a carrier having a sleeve and a food carrier, the carrier having a substantially planar, unassembled configuration that is expandable into a three-dimensional, assembled configuration, the method comprising:
opening the food carrier, the food carrier having at least two sides and a base, the base being connected to one of the sides and having at least one tab that engages with at least one corresponding aperture formed in another one of the sides;
inserting the at least one tab into the at least one corresponding aperture; and
opening the sleeve, the sleeve having a tapered configuration from a top opening to a bottom of the sleeve.

12. The method of claim 11, further comprising inserting a beverage container into an opening of the sleeve and inserting a food item into an opening of the food carrier.

13. The method of claim 11, wherein opening the food carrier comprises at least one of pressing inwardly on one of the sides of the food carrier and pressing upwardly on a portion of the base.

14. The method of claim 11, wherein opening the sleeve comprises at least one of pressing inwardly on an attachment portion of the sleeve and pulling outwardly on at least one of the opposed sides of the sleeve.

15. The method of claim 11, wherein opening the food carrier comprises moving the base into a position substantially perpendicular to the sides of the food carrier.

16. A method of assembling a carrier having a substantially planar, unassembled configuration that is expandable into a three-dimensional, assembled configuration, the method comprising:
creating a template for the carrier, the template having a first half and a second half, each one of the first half and the second half having a part of a sleeve and a part of a food carrier, the first half being connected to the second half;
creating fold lines in each one of the first half and the second half to define at least one side of the food carrier, a connector and at least one attachment portion;
applying glue lines to a first connector and a first attachment portion of the first half;
aligning the first connector and the first attachment portion of the first half with a second connector and a second attachment portion of the second half, respectively;
securing the first and second halves together to form an unassembled carrier comprising the sleeve having a tapered configuration from a top opening to a bottom of the sleeve and the food carrier having at least two sides and a base being connected to one of the sides, the base having at least one tab that engages with at least one corresponding aperture formed in another one of the sides;
opening the food carrier;
inserting the at least one tab into the at least one corresponding aperture; and
opening the sleeve.

17. The method of claim 16, wherein opening the food carrier comprises at least one of pressing inwardly on one of the sides of the food carrier and pressing upwardly on a portion of the base.

18. The method of claim 16, wherein opening the sleeve comprises at least one of pressing inwardly on an attachment portion of the sleeve and pulling outwardly on at least one of the opposed sides of the sleeve.

19. The method of claim 16, further comprising, scoring or perforating at least one of the at least one fold line.

20. A method of assembling a carrier having a substantially planar, unassembled configuration that is expandable into a three-dimensional, assembled configuration, the method comprising:
creating a template for the carrier, the template having a first half and a second half, each one of the first half and the second half having a part of a sleeve and a part of a food carrier;
creating fold lines in each one of the first half and the second half to define at least one side of the food carrier, a connector and at least one attachment portion;
applying glue lines to a first connector and a first attachment portion of the first half;
aligning the first connector and the first attachment portion of the first half with a second connector and a second attachment portion of the second half, respectively;
securing the first and second halves together to form an unassembled carrier comprising the sleeve having a tapered configuration from a top opening to a bottom of the sleeve and the food carrier having at least two sides and a base being connected to one of the sides, the base having at least one tab that engages with at least one corresponding aperture formed in another one of the sides;
opening the food carrier;
inserting the at least one tab into the at least one corresponding aperture; and
opening the sleeve.

21. A method of assembling a carrier having a substantially planar, unassembled configuration that is expandable into a three-dimensional, assembled configuration, the method comprising:
creating a template for the carrier, the template having a first half and a second half, each one of the first half and the second half having a part of a sleeve and a part of a food carrier, the first half being connected to the second half;
creating fold lines in each one of the first half and the second half to define at least one side of the food carrier;
forming slits in first half and corresponding slits in the second half;
engaging the slits of the first half with the corresponding slits of the second half to form an assembled carrier comprising the sleeve having a tapered configuration from a top opening to a bottom of the sleeve and the food carrier having at least two sides and a base being connected to one of the sides.
